(19) United States
(12) Patent Application Publication
(10) Pub. No.: US 2025/0186909 A1
(43) Pub. Date: Jun. 12, 2025

(54) Filter Layer Structure, Filter Assembly, and Method of Forming a Filter Layer Structure

(71) Applicant: QINGDAO ECOPURE FILTER CO., LTD, Qingdao (CN)

(72) Inventor: Zhibin ZOU, Qingdao (CN)

(21) Appl. No.: 18/972,826

(22) Filed: Dec. 6, 2024

(30) Foreign Application Priority Data
Dec. 7, 2023 (CN) 202323339487.X

(51) Int. Cl. B01D 29/01; B01D 29/07; B01D 35/30; B01D 39/20

(52) U.S. Cl. CPC B01D 29/016; B01D 29/012; B01D 29/073; B01D 35/30; B01D 39/2065; B01D 2201/347; B01D 2239/0421; B01D 2239/0618; B01D 2239/0654; B01D 2239/0695

(57) ABSTRACT

The disclosure provides a filter layer structure, a filter assembly, and a method of forming a filter layer structure. The filter layer structure has an unwound state. In the unwound state, the filter layer structure includes: a supporting layer; a first hydrophilic protective layer arranged on the supporting layer, where a first end of the first hydrophilic protective layer corresponds to a first end of the supporting layer; and a filter medium layer arranged on the supporting layer, where the filter medium layer extends along a length direction of the first hydrophilic protective layer, a first end of the filter medium layer faces a second end of the first hydrophilic protective layer, and a second end of the filter medium layer corresponds to a second end of the supporting layer.

### CROSS REFERENCE TO RELATED APPLICATIONS

The present disclosure claims benefit of Chinese Patent Application No. 202323339487.X, filed on Dec. 7, 2023, entitled “Filter Layer Structure, Filter Assembly, and Kettle”, the contents of which are hereby incorporated by reference in its entirety.

### TECHNICAL FIELD

The disclosure relates to the technical field of liquid purification, and specifically relates to a filter layer structure, a filter assembly, and a method of forming a filter layer structure.

### BACKGROUND

Generally, domestic water purifiers remove impurities in the water through the filter assembly to make the water drinkable. In the related art, a filter assembly includes a wound-type filter layer structure. Filter medium layers press each other while the filter layer structure is wound, such that the filter medium layers are compacted. Thus, a flow rate of filtered water is greatly reduced, influencing experience of using water.

### SUMMARY

A main objective of the disclosure is to provide a filter layer structure, a filter assembly and a method of forming a filter layer structure, so as to solve a problem that a filter medium layer in the related art is compacted to reduce a flow rate of filtered water.

To achieve the objective, one aspect of the disclosure provides a filter layer structure. The filter layer structure has an unwound state. In the unwound state, the filter layer structure includes: a supporting layer; a first hydrophilic protective layer arranged on the supporting layer, wherein a first end of the first hydrophilic protective layer corresponds to a first end of the supporting layer; and a filter medium layer arranged on the supporting layer, wherein the filter medium layer extends along a longitudinal direction of the first hydrophilic protective layer, a first end of the filter medium layer faces and is adjacent to a second end of the first hydrophilic protective layer, and a second end of the filter medium layer corresponds to a second end of the supporting layer.

In some embodiments, the filter layer structure further includes a second hydrophilic protective layer. A first end of the second hydrophilic protective layer is connected with the second end of the supporting layer. A second end of the second hydrophilic protective layer is located away from the second end of the supporting layer in a length direction of the supporting layer.

In some embodiments, a length of the supporting layer is greater than or equal to a length of the first hydrophilic protective layer. The second end of the first hydrophilic protective layer is shorter than or flush with the second end of the supporting layer.

In some embodiments, a length of the supporting layer is greater than or equal to a total length of the first hydrophilic protective layer and the filter medium layer.

In some embodiments, the filter layer structure further has a wound state. In a case that the filter layer structure is kept in the wound state, the supporting layer isolates the first hydrophilic protective layer from the filter medium layer in a direction from inside to outside of the filter layer structure.

In some embodiments, the filter layer structure further has a wound state. In a case that the filter layer structure is kept in the wound state, in a direction from inside to outside of the filter layer structure, a part of the supporting layer isolates the first hydrophilic protective layer from the filter medium layer, and another part of the supporting layer isolates the second hydrophilic protective layer from the filter medium layer.

In some embodiments, the first hydrophilic protective layer is located at an inner side of the filter medium layer. The first hydrophilic protective layer covers the inner side of the filter medium layer.

In some embodiments, the second hydrophilic protective layer is located at an outer side of the filter medium layer. The second hydrophilic protective layer covers the outer side of the filter medium layer.

In some embodiments, the filter medium layer is a carbon fiber layer. The first hydrophilic protective layer and the second hydrophilic protective layer are both non-woven fabric layers. The supporting layer is a net-like substrate.

Another aspect of the disclosure provides a filter assembly. The filter assembly includes a filter layer structure. The filter layer structure is the above filter layer structure. The filter assembly further includes a supporting frame. The filter layer structure is wound around the supporting frame. The supporting frame is provided with an internal channel. A side wall of the supporting frame is provided with a first through hole enabling pores of the filter layer structure to be in communication with the internal channel.

In some embodiments, the filter assembly further includes a top cover and a bottom cover. The top cover covers a first end of the supporting frame. A downward extending part of the top cover is inserted into the supporting frame. The bottom cover covers a second end of the supporting frame. The top cover is provided with a second through hole in communication with the internal channel. The filter layer structure covers the first through hole.

In some embodiments, the filter assembly further includes a housing accommodating the filter layer structure and the bottom cover. The housing is of a cylindrical structure with an opening at an upper portion. The upper portion of the housing is connected with the top cover. An overflow gap is enclosed among the housing, an outer side of the filter layer structure and an outer side of the bottom cover. The housing is provided with a third through hole in communication with the overflow gap.

In some embodiments, the top cover is provided with a sealing ring. The filter assembly is hermetically mounted on a water purification device by the sealing ring.

In some embodiments, the filter layer structure further includes a second hydrophilic protective layer, a first end of the second hydrophilic protective layer is connected with the second end of the supporting layer, and a second end of the second hydrophilic protective layer is located away from the second end of the supporting layer in a length direction of the supporting layer.

In some embodiments, the filter layer structure is kept in a wound state, n the radial direction of the filter layer structure, the supporting layer isolates a plurality of layers of the filter medium layer from each other.

In some embodiments, the filter layer structure is kept in a wound state, in a radial direction of the filter layer structure, a part of the supporting layer isolates the first hydrophilic protective layer from the filter medium layer, and another part of the supporting layer isolates the second hydrophilic protective layer from the filter medium layer.

In some embodiments, wherein the first hydrophilic protective layer is located at an outer side wall of the supporting frame, and the first hydrophilic protective layer covers the outer side wall of the supporting frame; and/or the first hydrophilic protective layer is located at an inner side of the filter medium layer, and the first hydrophilic protective layer covers the inner side of the filter medium layer; and/or the second hydrophilic protective layer is located at an outer side of the filter medium layer, and the second hydrophilic protective layer covers the outer side of the filter medium layer.

A method of forming a filter layer structure, including: positioning a supporting layer; arranging a first hydrophilic protective layer on the supporting layer, wherein a first end of the first hydrophilic protective layer corresponds to a first end of the supporting layer; disposing a filter medium layer above the supporting layer, wherein the filter medium layer extends along the longitudinal direction of the first hydrophilic protective layer; positioning and adjoining a first end of the filter medium layer towards a second end of the first hydrophilic protective layer, corresponding a second end of the filter medium layer to a second end of the supporting layer; wounding the positioned supporting layer, the positioned first hydrophilic protective layer and the positioned filter medium layer together to form the filter layer structure; wherein the filter layer structure is hollow and tubular, and the first hydrophilic protective layer constitutes the inner wall of the hollow tubular filtering layer structure, and the supporting layer separates the first hydrophilic protective layer and the filter medium layer.

In some embodiments, the filter layer structure further includes a second hydrophilic layer, connecting a first end of the second hydrophilic protective layer to the second end of the supporting layer, and then continuing to be wound in a winding direction of positioned supporting layer; furthermore, the second end of the second hydrophilic protective layer as end of the winding so that the second hydrophilic protective layer is configured to completely covers the supporting layer.

In some embodiments, the filter medium layer is a carbon fiber layer, the first hydrophilic protective layer and the second hydrophilic protective layer are both non-woven fabric layers, and the supporting layer is a net-like substrate.

Through the technical solution of the disclosure, the filter layer structure has the unwound state. In the unwound state, the filter layer structure includes: the supporting layer, the first hydrophilic protective layer, and the filter medium layer. The first hydrophilic protective layer is arranged on the supporting layer. The first end of the first hydrophilic protective layer corresponds to the first end of the supporting layer. The filter medium layer is arranged on the supporting layer. The filter medium layer extends along the length direction of the first hydrophilic protective layer. The first end of the filter medium layer faces the second end of the first hydrophilic protective layer. The second end of the filter medium layer corresponds to the second end of the supporting layer. In this way, in a process of winding the filter layer structure in the unwound state, the supporting layer can isolate a plurality of layers of the filter medium layer from each other, and isolate the first hydrophilic protective layer from the filter medium layer. Thus, a plurality of layers of the filter medium layer do not press each other, and the filter medium layer and the first hydrophilic protective layer do not press each other, and are prevented from being compacted. When water flows through the filter medium layer and the first hydrophilic protective layer, filter resistance of filtered water is reduced, desirable water permeability is achieved, and a flow rate of the filtered water is improved. Hence, the technical solution of the disclosure effectively solves a problem that a filter medium layer in the related art is compacted to reduce a flow rate of filtered water.

### BRIEF DESCRIPTION OF THE DRAWINGS

The accompanying drawings are used to provide further understanding of the disclosure as a constituent part of the disclosure, and illustrative examples of the disclosure and their descriptions are used to explain the disclosure and are not to be construed as unduly limiting the disclosure. In the drawings:

FIG. 1 is a schematic diagram showing that a solid structure of a filter layer structure of an example of a filter layer structure according to the disclosure is in an unwound state;

FIG. 2 is a schematic diagram showing that a solid structure of a filter layer structure of an example of a filter layer structure according to the disclosure is in a wound state;

FIG. 3 is a schematic structural diagram of an exploded view of an example of a filter assembly according to the disclosure;

FIG. 4 is a schematic diagram of a cutaway view of a filter assembly in FIG. 3; and

FIG. 5 is a schematic diagram of a solid structure of a filter layer structure and a supporting frame of a filter assembly in FIG. 3.

The above figures include the following reference numerals:

10, filter layer structure; 11, supporting layer; 12, first hydrophilic protective layer; 13, filter medium layer; 14, second hydrophilic protective layer;

21, supporting frame; 211, first through hole; 22, top cover; 221, second through hole; 23, bottom cover; 24, housing; 241, third through hole; 25, sealing ring.

### DETAILED DESCRIPTION OF THE EMBODIMENTS

Technical solutions of examples of the disclosure will be clearly and comprehensively described below with reference to accompanying drawings in the examples of the disclosure. Obviously, the examples described are merely some examples rather than all examples of the disclosure. The following description of at least one illustrative example is merely illustrative in nature and in no way serves as any limitation on the disclosure and its application or use. On the basis of the examples of the disclosure, all other examples derived by those of ordinary skill in the art without making inventive efforts fall within the protection scope of the disclosure.

It should be noted that the terms used herein are merely for describing the detailed description of embodiments and are not intended to limit illustrative embodiments according to the disclosure. As used herein, the singular is also intended to include the plural unless otherwise specified in the context. In addition, it should be understood that the terms “involve” and/or “comprise” or “include” used in the description indicate the presence of features, steps, operations, devices, assemblies, and/or their combinations.

It should be noted that relative arrangement, numerical expressions and numerical values of components and steps described in the examples do not limit the scope of the disclosure unless otherwise specified. Moreover, it should be understood that for convenience of description, dimensions of each part shown in the drawings are not drawn according to a real proportional relation. Technologies, methods and apparatuses known to those of ordinary skill in the related art may not be discussed in detail, but in appropriate cases, they should be regarded as part of the description. In all instances shown and discussed herein, any specific value should be interpreted as illustrative only, instead of being limitative. Therefore, different values are possible in other instances of the illustrative examples. It should be noted that like numerals and letters denote like items in the following accompanying drawings, and therefore, once an item is defined in one accompanying drawing, it does not need to be further discussed in the subsequent accompanying drawings.

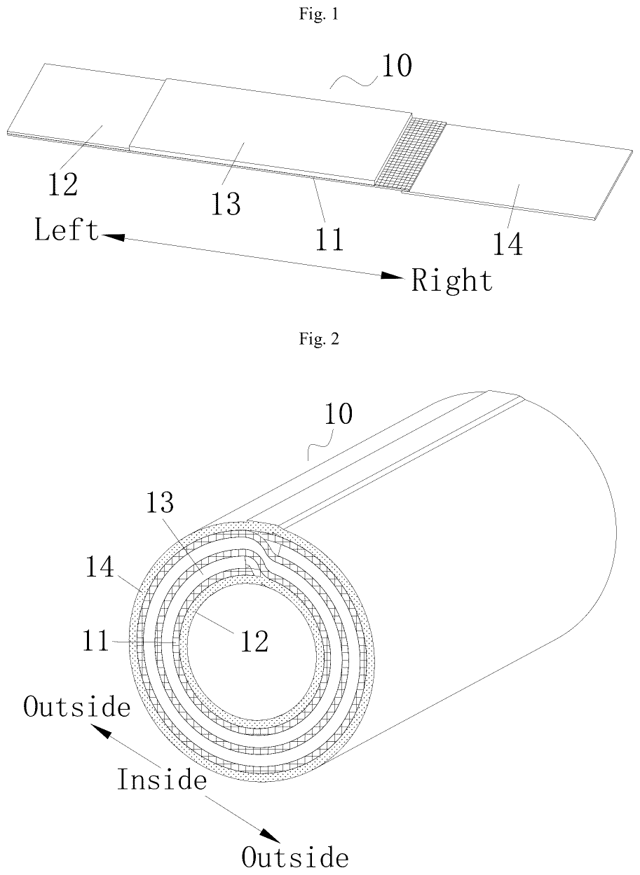

As shown in FIGS. 1 and 2, the disclosure provides a filter layer structure. The filter layer structure 10 has a unwound state. In the unwound state, the filter layer structure includes: a supporting layer 11; a first hydrophilic protective layer 12 arranged on the supporting layer 11, wherein a first end of the first hydrophilic protective layer 12 corresponds to a first end of the supporting layer 11; and a filter medium layer 13 arranged on the supporting layer 11, wherein the filter medium layer 13 extends along a length direction of the first hydrophilic protective layer 12, a first end of the filter medium layer 13 faces a second end of the first hydrophilic protective layer 12, and a second end of the filter medium layer 13 corresponds to a second end of the supporting layer 11.

Through the technical solution of the embodiment, in the unwound state, the filter layer structure includes: the supporting layer 11, the first hydrophilic protective layer 12, and the filter medium layer 13. In a process of winding the filter layer structure 10 in the unwound state from left to right, the supporting layer 11 can isolate a plurality of layers of the filter medium layer 13 from each other, and isolate the first hydrophilic protective layer 12 from the filter medium layer 13. Thus, a plurality of layers of the filter medium layer 13 do not press each other, and the filter medium layer 13 and the first hydrophilic protective layer 12 do not press each other, and are prevented from being compacted. When water flows through the filter medium layer 13 and the first hydrophilic protective layer 12, filter resistance of filtered water is reduced, desirable water permeability is achieved, and a flow rate of the filtered water is improved. Hence, the technical solution of the embodiment effectively solves a problem that a filter medium layer in the related art is compacted to reduce a flow rate of filtered water.

It should be noted that the description that the first end of the first hydrophilic protective layer 12 corresponds to the first end of the supporting layer 11 indicates that the first end of the first hydrophilic protective layer 12 and the first end of the supporting layer 11 are located at a same end of the filter layer structure. Similarly, the description that the second end of the filter medium layer 13 corresponds to the second end of the supporting layer 11 indicates that the second end of the filter medium layer and the second end of the supporting layer are located at a same end of the filter layer structure.

Specifically, an end surface of the first end of the filter medium layer 13 abuts against or is distanced from an end surface of the second end of the first hydrophilic protective layer 12, such that the first end of the filter medium layer 13 and the second end of the first hydrophilic protective layer 12 do not overlap each other in an up and down direction. The filter medium layer 13 is a carbon fiber layer. In the process of winding the filter layer structure 10 in the unwound state from left to right, the first hydrophilic protective layer covers an inner side of the filter medium layer 13, such that carbon fiber residues in the carbon fiber layer can be blocked.

As shown in FIGS. 1 and 2, the filter layer structure 10 further includes a second hydrophilic protective layer 14. A first end of the second hydrophilic protective layer 14 is connected with the second end of the supporting layer 11. A second end of the second hydrophilic protective layer 14 is located away from the second end of the supporting layer 11 in a length direction of the supporting layer 11. In the process of winding the filter layer structure 10 in the unwound state from left to right, the first hydrophilic protective layer 12 is located at the inner side of the filter medium layer 13, and the second hydrophilic protective layer 14 is located at an outer side of the filter medium layer 13. The supporting layer 11 is further capable of isolating the filter medium layer 13 from the second hydrophilic protective layer 14. In this way, the filter medium layer 13 is covered by the first hydrophilic protective layer 12 and the second hydrophilic protective layer 14 in a direction from inside to outside. Moreover, under the supporting action of the supporting layer 11, compactness of the filter medium layer 13 is ensured, and a filter medium of the filter medium layer 13 is prevented from being flushed into water, avoiding influence on a filter effect. In addition, the filter medium layer 13 and the second hydrophilic protective layer 14 do not press each other, and are prevented from being compacted. When water flows through the second hydrophilic protective layer 14 and the filter medium layer 13, filter resistance of filtered water is reduced, desirable water permeability is achieved, and a flow rate of the filtered water is improved.

Specifically, in the unwound state, the first end of the second hydrophilic protective layer 14 is located under the second end of the supporting layer 11.

As shown in FIGS. 1 and 2, a length of the supporting layer 11 is greater than or equal to a length of the first hydrophilic protective layer 12. The second end of the first hydrophilic protective layer 12 is shorter than or flush with the second end of the supporting layer. In this way, in a case of ensuring a filter effect of the filter medium layer 13, in the process of winding the filter layer structure 10 in the unwound state, the supporting layer 11 is capable of isolating the first hydrophilic protective layer 12 from the filter medium layer 13 while supporting the filter medium layer 13 and the first hydrophilic protective layer 12.

Specifically, a thickness of the filter medium layer 13 is greater than or equal to that of the first hydrophilic protective layer 12.

As shown in FIGS. 1 and 2, the length of the supporting layer 11 is greater than or equal to the total length of the first hydrophilic protective layer 12 and the filter medium layer 13. In this way, in the process of winding the filter layer structure 10 in the unwound state, it is ensured that the supporting layer 11 is capable of isolating the first hydrophilic protective layer 12 from the filter medium layer 13.

As shown in FIGS. 1 and 2, in order to ensure that the supporting layer 11 is capable of isolating the first hydrophilic protective layer 12 from the filter medium layer 13 all the time, the filter layer structure 10 further has a wound state starting from a first end of the first hydrophilic protective layer and ending at a second end of the second hydrophilic protective layer. In a case that the filter layer structure is kept in the wound state, the supporting layer 11 isolates the first hydrophilic protective layer 12 from the filter medium layer 13 in a direction from inside to outside of the filter layer structure 10.

As shown in FIGS. 1 and 2, in order to ensure that the supporting layer 11 is capable of isolating the first hydrophilic protective layer 12 from the filter medium layer 13 all the time and isolating the second hydrophilic protective layer 14 from the filter medium layer 13 all the time, the filter layer structure 10 further has a wound state starting from a first end of the first hydrophilic protective layer and ending at a second end of the second hydrophilic protective layer. In a case that the filter layer structure is kept in the wound state, in a direction from inside to outside of the filter layer structure 10, a part of the supporting layer 11 isolates the first hydrophilic protective layer 12 from the filter medium layer 13, and another part of the supporting layer 11 isolates the second hydrophilic protective layer 14 from the filter medium layer 13. In this way, the supporting layer 11 may be arranged to isolate a plurality of layers of the filter medium layer 13 from each other so as to form a water passage, such that a plurality of layers of the filter medium layer 13 are prevented from pressing each other, and the flow rate of the filtered water is greatly improved.

As shown in FIGS. 1 and 2, the first hydrophilic protective layer 12 is located at the inner side of the filter medium layer 13. The first hydrophilic protective layer 12 covers the inner side of the filter medium layer 13. The second hydrophilic protective layer 14 is located at the outer side of the filter medium layer 13. The second hydrophilic protective layer 14 covers the outer side of the filter medium layer 13. In some embodiments, two ends of the first hydrophilic protective layer 12 are connected with and completely cover the inner side of the filter medium layer 13. Two ends of the second hydrophilic protective layer 14 are connected with and completely cover the outer side of the filter medium layer 13. In this way, the filter medium layer 13 is effectively covered with the first hydrophilic protective layer 12 and the second hydrophilic protective layer 14 in a direction from inside to outside. Moreover, under the supporting action of the supporting layer 11, compactness of the filter medium layer 13 is ensured, and a filter medium of the filter medium layer 13 is prevented from being flushed into water, avoiding influence on a filter effect.

In a case that the filter layer structure 10 of the example is in the unwound state, the first hydrophilic protective layer 12 and the second hydrophilic protective layer 14 do not overlap each other, such that the filter layer structure 10 has a small volume. In addition, in a case that the filter layer structure 10 is kept in a wound state, a part of the supporting layer 11 isolates the first hydrophilic protective layer 12 from the filter medium layer 13, and another part of the supporting layer 11 isolates the second hydrophilic protective layer 14 from the filter medium layer 13, such that the filter medium layer 13, the first hydrophilic protective layer 12 and the second hydrophilic protective layer 14 do not directly overlap one another in the direction from inside to outside of the filter layer structure 10. In this way, all parts of the filter layer structure 10 are rationally arranged, assembly difficulty is reduced, and production efficiency can be improved.

In some embodiments, the connection of the two ends of the first hydrophilic protective layer 12 and the connection of the two ends of the second hydrophilic protective layer 14 may be both bonded or ultrasonically welded.

As shown in FIGS. 1 and 2, in order to ensure a filter effect of the filter layer structure 10, the filter medium layer 13 is a carbon fiber layer. The first hydrophilic protective layer 12 and the second hydrophilic protective layer 14 are both non-woven fabric layers. The supporting layer 11 is a net-like substrate.

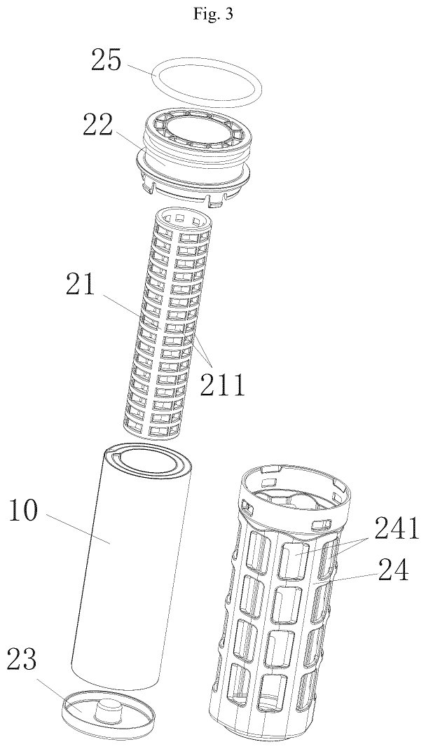

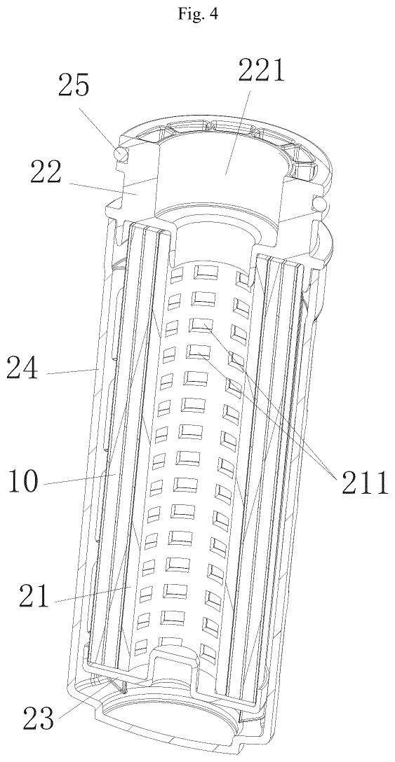

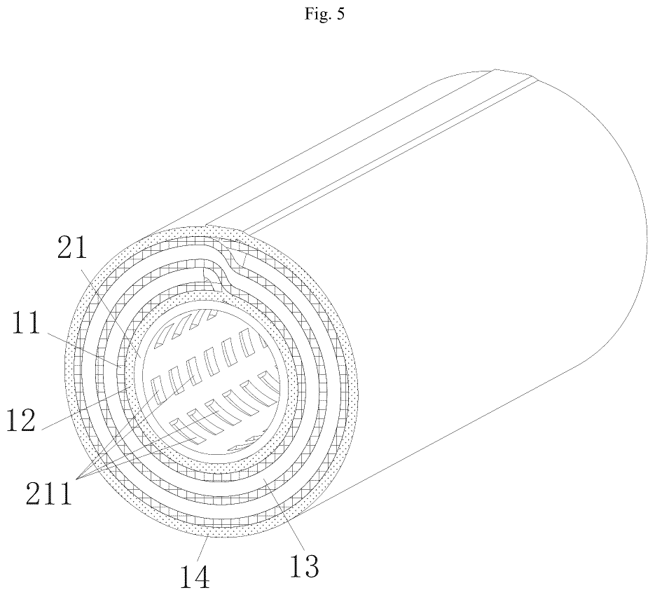

The disclosure further provides a filter assembly. As shown in FIGS. 3-5, the filter assembly includes a filter layer structure 10. The filter layer structure is the above filter layer structure. As the filter layer structure can solve a problem that a filter medium layer in the related art is compacted to reduce a flow rate of filtered water, the filter assembly including the filter layer structure can solve the same technical problem. The filter assembly further includes a supporting frame 21. The filter layer structure 10 is wound around the supporting frame 21. The supporting frame 21 is provided with an internal channel. A side wall of the supporting frame 21 is provided with at least one first through hole 211 enabling pores of the filter layer structure 10 to be in communication with the internal channel. Water is filtered from outside of the filter layer structure 10 through pores of the filter layer structure 10, and then flows into the internal channel through the first through hole 211. The supporting frame 21 is capable of supporting the filter layer structure 10, thus ensuring that the filter layer structure 10 can be stably kept in a wound state, preventing the filter layer structure 10 from being deflected by water flows after use for a period, and ensuring sealing performance and a filter effect.

As shown in FIGS. 3-5, in order to facilitate mounting of the filter assembly on a water purification device, the filter assembly further includes a top cover 22 and a bottom cover 23. The top cover 22 covers a first end of the supporting frame 21. A downward extending part of the top cover 22 is inserted into the supporting frame 21. The bottom cover 23 covers a second end of the supporting frame 21. The top cover 22 is provided with a second through hole 221 in communication with the internal channel. The filter layer structure 10 covers the first through hole 211. The top cover 22 and the bottom cover 23 are hermetically connected with the filter layer structure 10 separately. In this way, the top cover 22 is mounted on the water purification device, so as to implement mounting. Moreover, the top cover 22 and the bottom cover 23 can protect upper and lower ends of the filter layer structure 10 respectively.

As shown in FIGS. 3-5, the filter assembly further includes a housing 24 accommodating the filter layer structure 10 and the bottom cover 23. The housing 24 is of a cylindrical structure with an opening at an upper portion. The upper portion of the housing 24 is connected with the top cover 22. An overflow gap is enclosed among the housing 24, an outer side of the filter layer structure 10 and an outer side of the bottom cover 23. The housing 24 is provided with at least one third through hole 241 in communication with the overflow gap. The housing 24 can protect an outer side of the filter layer structure 10. Water flows from outside of the filter layer structure 10 into the third through hole 241, and then flows into pores of the filter layer structure 10 through the overflow gap, so as to be filtered to form filtered water. The filtered water flows into the internal channel from the first through hole 211, and then is poured out through the second through hole 221.

As shown in FIGS. 3-5, in order to ensure sealing performance of the filter assembly mounted on the water purification device, the top cover 22 is provided with a sealing ring 25. The filter assembly is hermetically mounted on the water purification device by the sealing ring 25.

As shown in FIGS. 1-5, the filter layer structure 10 is kept in a wound state, in a radial direction of the filter layer structure 10, a part of the supporting layer 11 isolates the first hydrophilic protective layer 12 from the filter medium layer 13, and another part of the supporting layer isolates the second hydrophilic protective layer 14 from the filter medium layer 13.

As shown in FIGS. 1-5, the filter layer structure 10 is kept in a wound state, in the radial direction of the filter layer structure 10, the supporting layer 11 isolates the a plurality of layers of the filter medium layer 13 from each other.

As shown in FIGS. 1-5, the first hydrophilic protective layer 12 is located at an inner side of the filter medium layer 13, and the first hydrophilic protective layer 12 covers the inner side of the filter medium layer 13.

As shown in FIGS. 1-5, the second hydrophilic protective layer 14 is located at an outer side of the filter medium layer 13, and the second hydrophilic protective layer 14 covers the outer side of the filter medium layer 13.

The disclosure further provides a pitcher. The pitcher includes a filter assembly. The filter assembly is the above filter assembly. As the filter assembly can solve a problem that a filter medium layer in the related art is compacted to reduce a flow rate of filtered water, the pitcher including the filter assembly can solve the same technical problem.

A method of forming a filter layer structure, including: positioning a supporting layer 11; arranging a first hydrophilic protective layer 12 on the supporting layer 11, wherein a first end of the first hydrophilic protective layer 12 corresponds to a first end of the supporting layer 11; disposing a filter medium layer 13 above the supporting layer 11, wherein the filter medium layer 13 extends along the longitudinal direction of the first hydrophilic protective layer 12; positioning and adjoining a first end of the filter medium layer 13 towards a second end of the first hydrophilic protective layer 12, corresponding a second end of the filter medium layer 13 to a second end of the supporting layer 11; wounding the positioned supporting layer 11, the positioned first hydrophilic protective layer 12 and the positioned filter medium layer 13 together to form the filter layer structure; wherein the filter layer structure is hollow and tubular, and the first hydrophilic protective layer constitutes the inner wall of the hollow tubular filtering layer structure, and the supporting layer separates the first hydrophilic protective layer and the filter medium layer.

In some embodiments, the filter layer structure further includes a second hydrophilic layer, connecting a first end of the second hydrophilic protective layer to the second end of the supporting layer, and then continuing to be wound in a winding direction of positioned supporting layer 11. Furthermore, the second end of the second hydrophilic protective layer as end of the winding so that the second hydrophilic protective layer is configured to completely cover the supporting layer.

In some embodiments, the filter medium layer 13 is a carbon fiber layer, the first hydrophilic protective layer 12 and the second hydrophilic protective layer 14 are both non-woven fabric layers, and the supporting layer 11 is a net-like substrate.

In the description of the disclosure, it should be understood that orientations or positional relations indicated by the orientation terms “front, rear, upper, lower, left, and right”, “transverse, vertical, perpendicular, and horizontal”, “top and bottom”, etc. are based on the orientations or positional relations shown in the accompanying drawings and are only for facilitating the description of the disclosure and simplifying the description. Unless otherwise specified, the orientation terms do not indicate or imply that an apparatus or element referred to must have a particular orientation or be constructed and operated in a particular orientation, and therefore cannot be interpreted as limiting the protection scope of the disclosure. The orientation terms “in and out” refer to inside and outside relative to an outline of each component itself.

For convenience of description, the spatial relative terms such as “over”, “on”, “on an upper surface” and “upper” can be used herein to describe spatial positional relations of one device or feature with other devices or features as shown in the drawings. It should be understood that the spatial relative terms are intended to involve different orientations in use or operation in addition to the orientation of the device described in the drawings. For instance, if the device in the drawings is inverted, the device described as “on” or “over” other devices or structures would then be positioned “under” or “below” other devices or structures. Therefore, the illustrative term “on” can include two orientations of “on” and “under”. The device can also be positioned in other different ways (rotated by 90 degrees or located at other orientations), and the spatial relative description used herein is interpreted accordingly.

In addition, it should be noted that the words “first” and “second” are used to define parts only for convenience of distinguishing corresponding parts. Unless otherwise stated, the above words have no special meaning, so they cannot be understood as limiting the protection scope of the disclosure.

What are described above are merely preferred examples of the disclosure and are not intended to limit the disclosure, and those skilled in the art can make various modifications and changes to the disclosure. Any modifications, equivalent substitutions, improvements, etc. within the spirit and principles of the disclosure are intended to fall within the protection scope of the disclosure.

1. A filter layer structure, wherein the filter layer structure has an unwound state, and in the unwound state, the filter layer structure comprises:
a supporting layer;
a first hydrophilic protective layer arranged on the supporting layer, wherein a first end of the first hydrophilic protective layer corresponds to a first end of the supporting layer; and
a filter medium layer disposed above the supporting layer, wherein the filter medium layer extends along a longitudinal direction of the first hydrophilic protective layer, a first end of the filter medium layer faces and is adjacent to a second end of the first hydrophilic protective layer, and a second end of the filter medium layer corresponds to a second end of the supporting layer.

2. The filter layer structure according to claim 1, wherein the filter layer structure further comprises a second hydrophilic protective layer, a first end of the second hydrophilic protective layer is connected with the second end of the supporting layer, and a second end of the second hydrophilic protective layer is located away from the second end of the supporting layer in a length direction of the supporting layer.

3. The filter layer structure according to claim 1, wherein a length of the supporting layer is greater than or equal to a length of the first hydrophilic protective layer, and the second end of the first hydrophilic protective layer is shorter than or flush with the second end of the supporting layer.

4. The filter layer structure according to claim 1, wherein a length of the supporting layer is greater than or equal to a total length of the first hydrophilic protective layer and the filter medium layer.

5. The filter layer structure according to claim 1, wherein the filter layer structure further has a wound state, and in a case that the filter layer structure is kept in the wound state, the supporting layer isolates the first hydrophilic protective layer from the filter medium layer in a direction from inside to outside of the filter layer structure.

6. The filter layer structure according to claim 2, wherein the filter layer structure further has a wound state, and in a case that the filter layer structure is kept in the wound state, in a direction from inside to outside of the filter layer structure, a part of the supporting layer isolates the first hydrophilic protective layer from the filter medium layer, and another part of the supporting layer isolates the second hydrophilic protective layer from the filter medium layer.

7. The filter layer structure according to claim 6, wherein the first hydrophilic protective layer is located at an inner side of the filter medium layer, and the first hydrophilic protective layer covers the inner side of the filter medium layer.

8. The filter layer structure according to claim 7, wherein the second hydrophilic protective layer is located at an outer side of the filter medium layer, and the second hydrophilic protective layer covers the outer side of the filter medium layer.

9. The filter layer structure according to claim 2, wherein the filter medium layer is a carbon fiber layer, the first hydrophilic protective layer and the second hydrophilic protective layer are both non-woven fabric layers, and the supporting layer is a net-like substrate.

10. A filter assembly, comprising a filter layer structure, wherein the filter layer structure is the filter layer structure according to claim 1, the filter assembly further comprises a supporting frame, the filter layer structure is wound around the supporting frame, the supporting frame is provided with an internal channel, and a side wall of the supporting frame is provided with at least one first through hole enabling pores of the filter layer structure to be in communication with the internal channel.

11. The filter assembly according to claim 10, wherein the filter assembly further comprises a top cover and a bottom cover, wherein the top cover covers a first end of the supporting frame, a downward extending part of the top cover is inserted into the supporting frame, the bottom cover covers a second end of the supporting frame, the top cover is provided with a second through hole in communication with the internal channel, and the filter layer structure covers the first through hole.

12. The filter assembly according to claim 11, wherein the filter assembly further comprises a housing accommodating the filter layer structure and the bottom cover, wherein the housing is of a cylindrical structure with an opening at an upper portion, the upper portion of the housing is connected with the top cover, an overflow gap is enclosed among the housing, an outer side of the filter layer structure and an outer side of the bottom cover, and the housing is provided with at least one third through hole in communication with the overflow gap.

13. The filter assembly according to claim 11, wherein the top cover is provided with a sealing ring, and the filter assembly is hermetically mounted on a water purification device by the sealing ring.

14. The filter assembly according to claim 10, wherein the filter layer structure further comprises a second hydrophilic protective layer, a first end of the second hydrophilic protective layer is connected with the second end of the supporting layer, and a second end of the second hydrophilic protective layer is located away from the second end of the supporting layer in a length direction of the supporting layer.

15. The filter assembly according to claim 10, wherein the filter layer structure is kept in a wound state, in a radial direction of the filter layer structure, the supporting layer isolates a plurality of layers of the filter medium layer from each other.

16. The filter assembly according to claim 14, wherein the filter layer structure is kept in a wound state, in a radial direction of the filter layer structure, a part of the supporting layer isolates the first hydrophilic protective layer from the filter medium layer, and another part of the supporting layer isolates the second hydrophilic protective layer from the filter medium layer.

17. The filter assembly according to claim 14, wherein the first hydrophilic protective layer is located at an outer side wall of the supporting frame, and the first hydrophilic protective layer covers the outer side wall of the supporting frame; and/or
the first hydrophilic protective layer is located at an inner side of the filter medium layer, and the first hydrophilic protective layer covers the inner side of the filter medium layer; and/or
the second hydrophilic protective layer is located at an outer side of the filter medium layer, and the second hydrophilic protective layer covers the outer side of the filter medium layer.

18. A method of forming a filter layer structure, comprising:
positioning a supporting layer;
arranging a first hydrophilic protective layer on the supporting layer, wherein a first end of the first hydrophilic protective layer corresponds to a first end of the supporting layer;
disposing a filter medium layer above the supporting layer, wherein the filter medium layer extends along the longitudinal direction of the first hydrophilic protective layer;
positioning and adjoining a first end of the filter medium layer towards a second end of the first hydrophilic protective layer,
corresponding a second end of the filter medium layer to a second end of the supporting layer;
wounding the positioned supporting layer, the positioned first hydrophilic protective layer and the positioned filter medium layer together to form the filter layer structure;
wherein the filter layer structure is hollow and tubular, and the first hydrophilic protective layer constitutes the inner wall of the hollow tubular filtering layer structure, and the supporting layer separates the first hydrophilic protective layer and the filter medium layer.

19. The method of forming the filter layer structure according to claim 18, wherein the filter layer structure further comprises a second hydrophilic layer,
connecting a first end of the second hydrophilic protective layer to the second end of the supporting layer, and then continuing to be wound in a winding direction of positioned supporting layer; furthermore, the second end of the second hydrophilic protective layer as end of the winding so that the second hydrophilic protective layer is configured to completely covers the supporting layer.

20. The method of forming the filter layer structure according to claim 19, wherein the filter medium layer is a carbon fiber layer, the first hydrophilic protective layer and the second hydrophilic protective layer are both non-woven fabric layers, and the supporting layer is a net-like substrate.
